(19) United States
(12) Patent Application Publication
(10) Pub. No.: US 2006/0185697 A1
(43) Pub. Date: Aug. 24, 2006

(54) Method of cleaning a washing machine or a dishwasher

(75) Inventors: Stefania Andriola, Brussel (BE); Marc Francois Theophile Evers, Strombeek-Bever (BE); Stefano Scialla, Rome (IT); Oreste Todini, Brussel (BE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/348,667

(22) Filed: Feb. 7, 2006

(30) Foreign Application Priority Data
Feb. 11, 2005 (EP) 05447021.6
May 11, 2005 (EP) 05076101.4

(51) Int. Cl. B08B 7/00

(52) U.S. Cl. 134/42; 510/202

(57) ABSTRACT

A method of cleaning the interior surfaces of a non-loaded washing machine or a non-loaded automatic dishwasher with a liquid composition, by forming in said washing machine or automatic dishwasher an aqueous liquor comprising water and said liquid composition, wherein said liquid composition comprises an acid system comprising formic acid and an acid forming a slightly water soluble calcium salt.

### TECHNICAL FIELD

The present invention relates to a method of cleaning a non-loaded washing machine or automatic dishwasher. In particular, the present invention relates to a method of cleaning the inside (i.e., interior surfaces such as dispensers, piping systems, heating elements, drawers, etc.) of a non-loaded washing machine or automatic dishwasher by removing from the interior surfaces of the washing machine or automatic dishwasher limescale deposits.

### BACKGROUND OF THE INVENTION

The interior surfaces of laundry washing machines and automatic dishwashers (“washing appliances”) are prone to soiling upon use. In particular, limescale deposits are formed on the interior surfaces of laundry washing machines and automatic dishwashers due to the hardness of the tap water used to wash laundry or dishes in these washing appliances. Indeed, upon heating the tap water in washing appliances, the calcium and magnesium carbonate present in the tap water (water hardness) becomes less water soluble and is deposited as limescale deposits on the interior surfaces (such as heating elements, drums, rubber hoses, pipes, pumps, stainless steel surfaces of the washing compartment) of the appliances. Over time, i.e., over a number of wash cycles, the limescale on the interior surfaces of the appliances starts to build up. This limescale deposits-buildup can lead to severe damage of the washing machines and automatic dishwashers. Indeed, for example rubber surfaces, such as hoses, can become brittle and lead to leakage and heating elements lose their heating efficacy.

In order to reduce the formation of limescale deposits in washing machines various products are on the market to be added with the laundry detergent for each washing cycle. Such products are for example marketed under the tradename Calgon®. Furthermore, in a number of automatic dishwashers a special salt compartment is present, which is filled with NaCl, in order to reduce the effect of water hardness. However, even though the formation of limescale deposits can be reduced using the above products, the formation of limescale deposits still occurs. Over time, this reduced limescale build-up can still lead to the above mentioned damage of washing appliance. Moreover, there are a number of consumers that refrain from adding limescale deposits reducing products into the normal washing cycle of their washing machines and/or fail to comply with the requirement to add salt into the automatic dishwashers.

In view thereof, products have been developed that are used to clean the interior surfaces of washing appliances (laundry washing machines and automatic dishwashers) in a separate cycle without any laundry or dishes present in the appliance. Indeed, such products are used in a non-loaded cycle as they are not compatible with laundry or dishes. Various products and product forms (liquid, powder and tablets) of such washing appliances cleaners are currently marketed.

Even though the currently available washing appliances cleaners show some performance in removing limescale deposits from the interior surfaces of laundry washing machines and automatic dishwashers, it has been found that the cleaning performance (i.e., the capability to remove limescale) can still be further improved. In particular, in view of the on-going trend to reduce the temperature and/or the cycle time at which such products are used, fast cleaning action is an important feature of washing appliances cleaners. The currently available washing appliances cleaners, in particular the liquid washing appliances cleaners, are usually based on citric acid.

It has been found that certain acids, such as phosphoric acid, sulfuric acid, oxalic acid, and the like, are preferred for use in washing appliances cleaners. Indeed, such acids show a better removal of limescale as compared to the currently used acids such as citric acid. Indeed, such acids are preferred over citric acid, as they have a lower pKa and/or molecular weight, and thereby provide a higher reserve acidity and/or a better weight effectiveness. In general, it has been found that acids like phosphoric acid, sulfuric acid and oxalic acid, show a better removal of limescale when used in washing appliances cleaners as compared to citric acid.

However, the Applicant has found that washing appliances cleaners comprising phosphoric acid, sulfuric acid, oxalic acid, and other acids having similar properties in view of Ca-salt formation, are not fully satisfactory from a consumer viewpoint especially regarding the limescale release properties. Indeed, it has been discovered that due to the formation of slightly water soluble calcium salts by such acids when applied to limescale deposits, the limescale removal performance is not optimal. Such slightly water soluble calcium salts can re-deposit on the surfaces that have been cleaned or on other interior surfaces of the washing machine or an automatic dishwasher to be cleaned. Furthermore, these water soluble calcium salts can inhibit the limescale removal performance of the acid by aggregating around the limescale, especially in interior areas of the washing machine or the automatic dishwasher wherein a low agitation of the aqueous liquor formed by water and a washing appliances cleaner occurs.

It is thus an objective of the present invention to provide a method of cleaning the interior surfaces of a washing machine or an automatic dishwasher using a washing appliances cleaner, which delivers effective cleaning performance (i.e., the capability to remove limescale deposits).

It has now been found that the method according to the present invention meets the above objective.

### SUMMARY OF THE INVENTION

The present invention encompasses a method of cleaning the interior surfaces of a non-loaded washing machine or a non-loaded automatic dishwasher with a liquid composition, by forming in said washing machine or automatic dishwasher an aqueous liquor comprising water and said liquid composition, wherein said liquid composition comprises an acid system comprising formic acid and an acid forming a slightly water soluble calcium salt.

### DETAILED DESCRIPTION OF THE INVENTION

Method of cleaning the interior surfaces of a non-loaded washing machine or a non-loaded automatic dishwasher

The present invention encompasses a method of cleaning the interior surfaces of a non-loaded washing machine or a non-loaded automatic dishwasher.

By “cleaning” it is meant herein fully or at least partially removing limescale (“limescale deposits”), as well as limescale-containing deposits such as: limescale-wash residues mixtures; limescale-soil mixture residues; limescale-wash residues-soil mixture; and/or other limescale-containing encrustations

By “interior surfaces of washing machines or automatic dishwashers” it is meant herein surfaces of washing machines or automatic dishwashers that come into contact with the wash liquor formed upon normal operation of such washing appliances. Such interior surfaces of washing machines or automatic dishwashers include: heating elements; rubber or metal hoses; drums; pumps and piping systems; stainless steel or ceramic surfaces forming the inside of the washing compartment; drawers, dispensers and dosing compartments; filters; dish and/or cutlery racks; and the like.

By “non-loaded” washing machines or automatic dishwashers it is meant herein, washing machines or automatic dishwashers that do not contain any items, such as laundry items or dishes/cutlery respectively, which are commonly cleaned, washed or treated in the washing machines or automatic dishwashers. However, the washing machines or automatic dishwashers contain an aqueous liquor comprising water and the liquid composition of the present invention as well as loose or removably attached items such as filters or racks, forming part of the washing machine or automatic dishwasher, and may also comprise dosing means for the liquid composition of the present invention, such as a dosing ball, a dosing sachet, and the like.

The method of cleaning the interior surfaces of a non-loaded washing machine or a non-loaded automatic dishwasher herein comprises the step of forming in said washing machine or automatic dishwasher an aqueous liquor comprising water and a liquid composition. A suitable means for forming in said washing machine or automatic dishwasher the aqueous liquor is to operate a wash cycle of said washing machine or automatic dishwasher. Said wash cycle may be any wash cycle pre-programmed or programmable of said washing machine or automatic dishwasher, provided it involves the use of water. Indeed, said wash cycle may be a full wash cycle, including pre- and main-wash, or a main-wash cycle or a pre-wash cycle or a rinse cycle. Preferably, the wash cycle of said washing machine or automatic dishwasher is a short cycle such as a delicate laundry cycle for a washing machine or a pre-wash or economical/ecological cycle for an automatic dishwasher. In a preferred embodiment, the process herein additionally comprises a rinsing step, preferably after the cycle in which the liquid composition herein performs its action.

The method according to the present invention may be performed at any temperature selection of the washing machine or automatic dishwasher. Indeed, the temperature may be from the unheated temperature of the feed-water up to about 95° C. Preferably, the method according to the present invention includes using the acidic aqueous liquor at a temperature of from unheated to about 95° C., more preferably from unheated to about 70° C., even more preferably from about 30° C. to about 60° C.

In the method according to the present invention, the liquid composition herein is combined, preferably diluted, with water to form an aqueous liquor.

The liquid composition herein may be delivered into the washing machine or automatic dishwasher either by charging the dispenser drawer of the washing machine or the dispenser compartment of the automatic dishwasher with the liquid composition or by directly charging the drum of the washing machine or the washing compartment of the automatic dishwasher with the liquid composition. The liquid composition may be directly placed into the drum of the washing machine or the washing compartment of the automatic dishwasher, preferably using a dosing device, such as a dosing ball (such as the Vizirette®).

During the method according to the present invention the liquid composition herein is typically diluted in up to about 2000 times by volume, preferably from about 10 to about 1500 times by volume, more preferably from about 15 to about 1000 times by volume, and most preferably about 15 to about 50 times with water (preferably tap-water).

In the process according to the present invention an aqueous liquor is formed. Said liquor is formed in said washing machine or automatic dishwasher and thus comes into direct contact with the interior surfaces of washing machines or automatic dishwashers. Due to the agitation (such as drum rotation), spraying and/or pumping of said liquor upon execution of a wash cycle in the washing machine or automatic dishwasher, the interior surfaces of washing machines or automatic dishwashers are contacted with the wash liquor herein.

In a preferred embodiment herein, in the method of cleaning the interior surfaces of a non-loaded washing machine or a non-loaded automatic dishwasher herein, an acidic aqueous liquor comprising water and the liquid composition herein is formed. The acidity of the liquor is preferably contributed by the liquid composition as described herein below. The aqueous liquor preferably maintains an acidic pH over the course of the process of cleaning as described herein. Upon rinsing of the washing machine or automatic dishwasher, if any, or in the case of a heavily limescale-contaminated washing machine or automatic dishwasher (i.e., a washing machine or automatic dishwasher wherein the interior surfaces are severely encrusted with limescale) the pH may eventually rise either due to the increased dilution of the aqueous liquor with water and the increased dilution of the acidity found therein or due to the total consumption of the acidity in the liquid composition.

The Liquid Composition

In the method of cleaning the interior surfaces of a non-loaded washing machine or a non-loaded automatic dishwasher herein, a liquid composition comprising an acid system comprising formic acid and an acid forming slightly water soluble calcium salts is used.

The composition herein is a liquid composition, as opposed to a gas or solid composition.

The liquid composition herein is preferably an aqueous composition and may comprise from about 70% to about 99% by weight of the total composition of water, preferably from about 75% to about 95% and more preferably from about 80% to about 90%.

The liquid compositions of the present invention are preferably acidic. Therefore, the liquid compositions herein have a pH measured at 25° C., preferably of at least, with increasing preference in the order given, preference in the order given, about 0.1, 0.5, 1, 1.5, 2, 2.5, 3, 3.5, 4. Independently, the liquid compositions herein have a pH measured at 25° C., preferably of no more than, with increasing preference in the order given, about 12, 11.5, 11, 10.5, 10, 9.5, 9, 8.5, 8, 7.5, 7, 6.5, 6, 5.5, 5, 4.5, 4, 3.5, 3, 2.5.

Preferably, the liquid compositions herein have a viscosity of up to about 2000 cps at 20 s⁻¹, more preferably from about 1 cps to about 1500 cps, yet more preferably from about 20 cps to about 800 cps and most preferably from about 30 cps to about 600 cps at 20 s⁻¹ and 20° C. when measured with a Carri-Med Rheometer model CSL² 100® (Supplied by TA Instruments) with a 4 cm conic spindle in stainless steal (linear increment from 0.1 to 100 s⁻¹ in max. 8 minutes).

The compositions herein may comprise an alkaline material. Examples of alkaline material are caustic, preferably hydroxides of metals or ammonia, more preferably sodium hydroxide or potassium hydroxide, even more preferable NaOH. An alkaline material may be present to trim the pH and/or maintain the pH of the compositions according to the present invention. Despite the presence of an alkaline material, if any, the compositions herein would preferably remain acidic compositions (i.e., formulated with a pH below 7).

The cleaning performance for limescale deposits of the compositions herein may be evaluated by the Limescale Removal Performance Test Method, wherein a marble chip is dissolved in an aqueous liquor, as described herein below. Indeed, marble chip are chemically speaking very similar to limescale, i.e., they are essentially made of calcium carbonate, which is chemically similar or even identical to limescale encrustations formed inside washing appliances (e.g., on the heating elements).

Limescale Removal Performance Test Method: An aqueous liquor is formed by diluting (50× dilution) 2 grams of liquid composition to be tested in 100 grams (100 ml) of water (either soft (5 gpg) or hard (20 gpg) water). Thereafter, the aqueous liquor is heated to a temperature of 50° C. and the temperature is maintained during the test. The limescale removal capacity of the liquid composition to be tested is evaluated by soaking a given marble chip in 20 g of the aqueous liquor. During soaking the aqueous liquor is stirred at 100 rpm to mimic the rotation of a washing appliance. The given marble chip is weighed before and after the experiment, and the performance is expressed in grams of marble chip dissolved over time. Alternatively, limescale removal performance can also be evaluated by detecting the release of CO₂ during the test.

Acid System

The composition according to the present invention comprises an acid system comprising formic acid and an acid forming a slightly water soluble calcium salt.

The composition herein preferably comprises from about 1.01% to about 28% by weight of the total composition, preferably about 5.5% to about 22% by weight of the total composition, more preferably about 11% to about 19% by weight of the total composition, and most preferably about 11.5% to about 17% by weight of the total composition of said acid system.

The acid system herein provides excellent limescale removal performance.

Preferably, the acid system herein is present in a sufficient amount to form an acidic aqueous liquor preferably having a pH of below about 4. By “sufficient amount to form an acidic aqueous liquor having a pH of below about 4” it is meant herein that upon dissolution or dilution into 20 times the composition's weight of conventional tap water (i.e., 250 ml of composition in 5000 ml (5 lt.) of water) a pH of below about 4 measured at 25° C. is provided. The 20 times dilution above is equivalent to the average dilution achieved in a common washing machine or an automatic dishwasher. As indicated herein above, the pH of the wash liquor formed in the method according to the present invention may change due to dilution, acid consumption (i.e., removal of limescale) and/or other factors. Therefore, by “forming an acidic aqueous liquor preferably having a pH of below about 4”, it is preferably meant herein forming such an aqueous liquor at least once during the method herein.

In a preferred embodiment the acid herein is present in a sufficient amount to form an acidic aqueous liquor having a pH of below about 3.8, preferably below about 3.5, more preferably from about 0.5 to about 3.5, even more preferably from about 1.0 to about 3.0 and most preferably from about 1.5 to about 3.0.

The compositions according to the present invention comprise an acid system, wherein the acid system comprises formic acid and an acid forming a slightly water soluble calcium salt.

As a first element the acid system herein comprises formic acid. Formic acid is commercially available from FLUKA.

The compositions of the present invention may comprise from about 0.01% to about 3% by weight of the total composition of formic acid, preferably from about 0.5% to about 2%, more preferably from about 1% to about 2%, most preferably from about 1.5% to about 2%.

As a second element the acid system herein comprises an acid forming a slightly water soluble calcium salt. By “slightly water soluble calcium salt”, it is meant herein any calcium salts having a water solubility of about 2.5% w/w and below, in distilled water at 10-40° C. (preferably at 20° C.). Preferably, the slightly water soluble calcium salt can originate from any of the dissociations of the acid forming the salt. Indeed, e.g., for phosphoric this is the second and the third dissociation.

In a preferred embodiment, the compositions of the present invention comprise an acid system comprising an acid forming a substantially water insoluble calcium salt, more preferably an acid forming a water insoluble calcium salt. By “substantially water insoluble calcium salt”, it is meant herein any calcium salts having a water solubility of about 0.5% w/w and below (preferably 0.3% w/w and below), in distilled water at 10-40° C. (preferably at 20° C.). By “water insoluble calcium salt”, it is meant herein any calcium salts having a water solubility of about 0.001% w/w and below, in distilled water at 10-40° C. (preferably at 20° C.).

In the context of the present invention, the compositions comprise an acid system comprising an acid forming calcium salts typically having a water solubility up to about 2.5% w/w, preferably up to about 0.5% w/w, more preferably up to about 0.3% w/w and most preferably about 0.001% w/w, in distilled water at 10-40° C. (preferably at 20° C.).

Typically, the acid forming a slightly water soluble calcium salt to be used herein may be an inorganic acid, or an organic acid, or a mixture thereof.

A suitable inorganic acid forming a slightly water soluble calcium salt is selected from the group consisting of: phosphoric acid; and sulfuric acid; and mixtures thereof. Preferably, the inorganic acids for use herein have a first pKa of less than about 3.

A suitable organic acid forming a slightly water soluble calcium salt is oxalic acid. Preferably, the organic acids for use herein have a pKa or have a first pKa of less than about 5, preferably not exceeding about 4.5.

A preferred acid forming a slightly water soluble calcium salt is selected from the group consisting of: oxalic acid; phosphoric acid; and sulfuric acid; and mixtures thereof. More preferably, the acid forming a slightly water soluble calcium salt is phosphoric acid.

Therefore, typical examples of slightly water soluble calcium salts, which may be formed in the context of the present invention are calcium orthophosphate monobasic Ca(H₂PO₄)₂ (solubility of about 1.8% w/w in distilled water at 30° C.), calcium orthophosphate dibasic CaHPO₄ (solubility of about 0.0316% w/w in distilled water at 38° C.), calcium orthophosphate tribasic Ca₃(PO₄)₂ (solubility of about 0.002% w/w in distilled water at 20° C.), calcium sulfate CaSO₄ (solubility of about 0.209% w/w in distilled water at 30° C.), calcium sulfate half-hydrate CaSO₄.½H₂O (solubility of about 0.3% w/w in distilled water at 20° C.), calcium sulfate dihydrate CaSO₄.2H₂O (solubility of about 0.241% w/w in distilled water at 20° C.), and calcium oxalate CaC₂O₄ (solubility of about 0.0067% w/w in distilled water at 13° C.).

Preferably, for the purpose of the present invention, it is sufficient that by the acid forming slightly water soluble calcium salts at least one slightly water soluble calcium salt is formed.

In a highly preferred embodiment of the present invention, the acid system comprises formic acid and phosphoric acid.

Phosphoric acid is commercially available for example from J. T. Baker, Prayon or Thermphos, sulfuric acid is commercially available for example from BASF, Bayer or Prayon, oxalic acid is commercially available for example from Orgsintez (Russia), Merck or Clariant.

Furthermore, the compositions of the present invention may comprise from about 1% to about 25% by weight of the total composition of an acid forming a slightly water soluble calcium salt, or mixtures thereof, preferably from about 5% to about 20%, more preferably from about 10% to about 17%, most preferably from about 10% to about 15%.

Due to the difference in pKa and/or strengths of different acids, the level of acid forming a slightly water soluble calcium salt may vary.

It has been unexpectedly found that washing appliances cleaners comprising an acid system, wherein said acid system comprises formic acid and an acid forming a slightly water soluble calcium salt, provide an improved limescale removal performance, as compared to the cleaning performance obtained with the same compositions but in absence of formic acid. This unexpected limescale removal performance improvement is particularly outstanding in parts of the washing machine or dishwasher to be cleaned wherein little agitation is provided, i.e., where the interior surfaces of such appliances are stationary and a limited flow (for example by pumping of aqueous liquor) exists. Such interior surfaces can for example be found in U-tubes and pipelines as well as at the bottom of the drum.

Without wishing to be bound by theory, it is believed that formic acid participates in reducing the precipitation of slightly soluble calcium salts that could be formed as a result of the interaction between calcium carbonate-containing material and an acid-containing cleaning composition. In the case of a washing appliances cleaner comprising an acid system wherein the slightly soluble calcium salt forming acid is phosphoric acid, it is likely that Ca(H₂PO₄)₂ and/or CaHPO₄ salt be formed. If the slightly soluble calcium salt forming acid is oxalic acid, it is likely that Ca(HC₂O₄)₂ and/or CaC₂O₄ salt be formed. If the slightly soluble calcium salt forming acid is sulfuric acid, it is likely that CaSO₄ salt be formed.

It has been discovered herein that formation of CaHPO₄ or other slightly water soluble calcium salts (such as Ca(H₂PO₄)₂, Ca(HC₂O₄)₂, CaC₂O₄ or CaSO₄) is particularly increased when the washing appliances cleaner is used on interior surfaces of appliances where little agitation of the aqueous liquor containing it occurs. Under such conditions, the above-mentioned slightly soluble calcium salts may even aggregate and form a crystalline shield around the limescale stain, and then prevent the acid to proceed with its acidic action. In general, regardless of the amount of agitation, the formed slightly soluble calcium salts may also re-deposit on interior surfaces of washing appliance (washing machines or dishwasher) and form deposits on these surfaces. Such deposits of slightly soluble calcium salts may be harmful to the washing appliances. Indeed, for example rubber surfaces, such as hoses, can become brittle and lead to leakage and heating elements lose their heating efficacy due to such re-deposition of soluble calcium salts.

It has been surprisingly found that the presence of formic acid in washing appliances cleaners comprising an acid forming a slightly water soluble calcium salt helps in reducing the formation of soluble calcium salts, such as CaHPO₄ salt and other slightly water soluble calcium salts as described herein, by protonation action and by scavenging free calcium cation Ca⁺².

A further advantage associated with the use of formic arises from its highly weight effectiveness due its low molecular weight.

However, due to environmental and/or consumer safety legislation in certain countries, the use of high amounts of formic acid, such as more than about 3%, in washing appliances cleaners would not be acceptable. Hence, the use of formic as the sole acid is not feasible as the requested high levels of formic acid needed to achieve good limescale removal performance would not be tolerated by the above-mentioned legislations.

Nonionic Surfactant

The compositions of the present invention comprise as an optional but highly preferred ingredient a nonionic surfactant, or a mixture thereof.

Suitable nonionic surfactants for use herein are alkoxylated alcohol nonionic surfactants which can be readily made by condensation processes which are well-known in the art. However, a great variety of such alkoxylated alcohols, especially ethoxylated and/or propoxylated alcohols is also conveniently commercially available. Surfactants catalogs are available which list a number of surfactants, including nonionics.

Accordingly, preferred alkoxylated alcohols for use herein are nonionic surfactants according to the formula RO(E)e(P)pH where R is a hydrocarbon chain of from about 2 to about 24 carbon atoms, E is ethylene oxide and P is propylene oxide, and e and p which represent the average degree of, respectively ethoxylation and propoxylation, are of from about 0 to about 24. The hydrophobic moiety of the nonionic compound can be a primary or secondary, straight or branched alcohol having from about 8 to about 24 carbon atoms.

Preferred nonionic surfactants for use in the compositions according to the invention are the condensation products of ethylene oxide with alcohols having a straight alkyl chain, having from about 6 to about 22 carbon atoms, wherein the degree of ethoxylation is from about 1 to about 15, preferably from about 5 to about 12. Such suitable nonionic surfactants are commercially available from Shell, for instance, under the trade name Dobanol® or from BASF under the trade name Lutensol®.

The compositions of the present invention may comprise up to about 15% by weight of the total composition of a nonionic surfactant or a mixture thereof, preferably from about 0.1% to about 15%, more preferably from about 1% to about 10%, even more preferably from about 1% to about 5%, and most preferably from about 2% to about 3%.

It has now been surprisingly discovered that a composition comprising an acid forming a slightly water soluble calcium salt, in particular phosphoric acid, and a nonionic surfactant provides outstanding performances in terms of soap scum removal from interior surfaces of washing machines and dishwashers. According to the present invention, such a remarkable performance is due to a highly and unexpected synergetic effect between said acid forming a slightly water soluble calcium salt, preferably phosphoric acid, and a nonionic surfactant.

In a preferred embodiment, wherein the compositions herein additionally comprise a nonionic surfactant, the acid forming a slightly water soluble calcium salt herein is phosphoric acid.

Chelating Agents

The compositions of the present invention may comprise as a highly preferred but optional ingredient a chelating agent. Chelating agents scavenge Ca-ions and therefore may further contribute to the limescale removal performance of the compositions herein.

Suitable phosphonate chelating agents for use herein may include alkali metal ethane 1-hydroxy diphosphonates (HEDP), ethane 1-hydroxy diphosphonic acid (HEDP); alkylene poly (alkylene phosphonate), as well as amino phosphonate compounds, including amino aminotri (methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al.(incorporated herein by reference). Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins (incorporated herein by reference). Ethylenediamine N,N′-disuccinic acids is, for instance, commercially available under the tradename ssEDDS® from Palmer Research Laboratories.

Suitable amino carboxylates to be used herein include ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents to be used herein include salicylic acid, aspartic acid, glutamic acid, glycine, malonic acid or mixtures thereof.

Another chelating agent for use herein is of the formula: 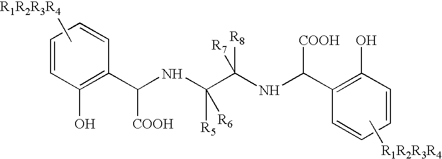
wherein R₁, R₂, R₃, and R₄ are independently selected from the group consisting of —H, alkyl, alkoxy, aryl, aryloxy, —Cl, —Br, —NO₂, —C(O)R′, and —SO₂R″; wherein R′ is selected from the group consisting of —H, —OH, alkyl, alkoxy, aryl, and aryloxy; R″ is selected from the group consisting of alkyl, alkoxy, aryl, and aryloxy; and R₅, R₆, R₇, and R₈ are independently selected from the group consisting of —H and alkyl.

Particularly preferred chelating agents to be used herein are amino aminotri (methylene phosphonic acid), di-ethylene-triamino-pentaacetic acid, diethylene triamine penta methylene phosphonate, 1-hydroxy ethane diphosphonate, 1-hydroxy ethane diphosphonic acid, ethylenediamine N,N′-disuccinic acid, and mixtures thereof. Most preferred chelating agents to be used herein are 1-hydroxy ethane diphosphonate, 1-hydroxy ethane diphosphonic acid, and mixtures thereof.

Typically, the compositions according to the present invention comprise up to about 5% by weight of the total composition of a chelating agent, or mixtures thereof, preferably from about 0.01% to about 1.5% by weight and more preferably from about 0.01% to about 0.5%.

Other Optional Ingredients

The liquid compositions herein may further comprise a variety of other optional ingredients such as vinylpyrrolidone homopolymer or copolymer, polysaccharide polymer, bleaches, surfactants, radical scavengers, antioxidants, stabilisers, builders, perfumes, pigments, dyes and the like.

Vinylpyrrolidone Homopolymer or Copolymer

The compositions of the present invention may optionally comprise a vinylpyrrolidone homopolymer or copolymer, or a mixture thereof. Typically, the compositions of the present invention may comprise from about 0.01% to about 5% by weight of the total composition of a vinylpyrrolidone homopolymer or copolymer, or a mixture thereof, more preferably from about 0.05% to about 3% and most preferably from about 0.05% to about 1%.

Suitable vinylpyrrolidone homopolymers for use herein are homopolymers of N-vinylpyrrolidone having the following repeating monomer: 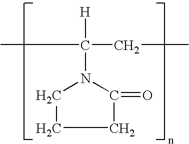
wherein n (degree of polymerisation) is an integer of from about 10 to about 1,000,000, preferably from about 20 to about 100,000, and more preferably from about 20 to about 10,000.

Accordingly, suitable vinylpyrrolidone homopolymers (“PVP”) for use herein have an average molecular weight of from about 1,000 to about 100,000,000, preferably from about 2,000 to about 10,000,000, more preferably from about 5,000 to about 1,000,000, and most preferably from about 50,000 to about 500,000.

Suitable vinylpyrrolidone homopolymers are commercially available from ISP Corporation, New York, N.Y. and Montreal, Canada under the product names PVP K-15® (viscosity molecular weight of 10,000), PVP K-30® (average molecular weight of 40,000), PVP K-60® (average molecular weight of about 160,000), and PVP K-90® (average molecular weight of about 360,000). Other suitable vinylpyrrolidone homopolymers which are commercially available from BASF Cooperation include Sokalan HP 165®, Sokalan HP 12®, Luviskol K30®, Luviskol K60®, Luviskol K80®, Luviskol K90®; vinylpyrrolidone homopolymers known to persons skilled in the detergent field (see for example EP-A-262,897 and EP-A-256,696—both of which are incorporated by reference herein).

Suitable copolymers of vinylpyrrolidone for use herein include copolymers of N-vinylpyrrolidone and alkylenically unsaturated monomers or mixtures thereof.

The alkylenically unsaturated monomers of the copolymers herein include unsaturated dicarboxylic acids such as maleic acid, chloromaleic acid, fumaric acid, itaconic acid, citraconic acid, phenylmaleic acid, aconitic acid, acrylic acid, N-vinylimidazole and vinyl acetate. Any of the anhydrides of the unsaturated acids may be employed, for example acrylate, methacrylate. Aromatic monomers like styrene, sulphonated styrene, alpha-methyl styrene, vinyl toluene, t-butyl styrene and similar well known monomers may be used.

For example particularly suitable N-vinylimidazole N-vinylpyrrolidone polymers for use herein have an average molecular weight range from about 5,000 to about 1,000,000, preferably from about 5,000 to about 500,000, and more preferably from about 10,000 to about 200,000. The average molecular weight range was determined by light scattering as described in Barth H. G. and Mays J. W. Chemical Analysis Vol 113, “Modern Methods of Polymer Characterization”.

Such copolymers of N-vinylpyrrolidone and alkylenically unsaturated monomers like PVP/vinyl acetate copolymers are commercially available under the trade name Luviskol® series from BASF.

According to a very preferred execution of the present invention, vinylpyrrolidone homopolymers are advantageously selected.

Polysaccharide Polymer

The compositions of the present invention may optionally comprise a polysaccharide polymer or a mixture thereof. Typically, the compositions of the present invention may comprise from about 0.01% to about 5% by weight of the total composition of a polysaccharide polymer or a mixture thereof, more preferably from about 0.05% to about 3% and most preferably from about 0.05% to about 1%.

Suitable polysaccharide polymers for use herein include substituted cellulose materials like carboxymethylcellulose, ethyl cellulose, hydroxyethyl cellulose, hydroxypropyl cellulose, hydroxymethyl cellulose, succinoglycan and naturally occurring polysaccharide polymers like xanthan gum, guar gum, locust bean gum, tragacenth gum or derivatives thereof, or mixtures thereof.

Particularly polysaccharide polymers for use herein are xanthan gum and derivatives thereof. Xanthan gum and derivatives thereof may be commercially available for instance from Kelco under the trade name Keltrol RD®, Kelzan S® or Kelzan T®. Other suitable Xanthan gum is commercially available by Rhone Poulenc under the trade name Rhodopol T® and Rhodigel X747®. Succinoglycan gum for use herein is commercially available by Rhone Poulenc under the trade name Rheozan®.

Without intended to be bound by theory, it has been shown that vinylpyrrolidone homopolymers or copolymers, preferably the vinylpyrrolidone homopolymer, and polysaccharide polymers, preferably xanthan gum or derivatives thereof, described herein, when added into the composition herein deliver long lasting protection against the deposition of limescale deposits.

Other Surfactants

The compositions of the present invention may comprise a surfactant or a mixture thereof in addition to the highly preferred nonionic surfactant that may be present in eth compositions herein. Said surfactant includes anionic surfactants, cationic surfactants, zwitterionic surfactants and/or amphoteric surfactants.

Typically, the compositions according to the present invention may comprise from about 0.01% to about 50% by weight of the total composition of a surfactant selected from the group consisting of: anionic surfactants; cationic surfactants; zwitterionic surfactants; and amphoteric surfactants; and mixtures thereof, preferably from about 0.1% to about 30% and more preferably from about 0.2% to about 10%.

Minor Ingredients

The composition described herein may also comprise minor ingredients such as pigment or dyes and perfumes.

Perfume

Suitable perfume compounds and compositions for use herein are for example those described in EP-A-0957156 under the paragraph entitled “Perfume” in page 13 (incorporated herein by reference).

In a highly preferred embodiment of the present invention, the compositions herein comprise a perfume composition selected from the group consisting of floral acetate, eucalyptol, and mixtures thereof. Indeed, it has been found that such perfumes are especially effective in covering the odor of formic acid.

The compositions herein may comprise a perfume ingredient, or mixtures thereof, in amounts up to about 5.0% by weight of the total composition, preferably in amounts of about 0.1% to about 1.5%.

Packaging Form of the Compositions:

Depending on the end-use envisioned, the compositions herein can be packaged in a variety of containers including conventional boxes, tubs, bottles etc.

The invention is further illustrated by the following examples.

### EXAMPLES

The following examples will further illustrate the present invention. The compositions are made by combining the listed ingredients in the listed proportions (weight % unless otherwise specified). The following Examples are meant to exemplify compositions according to the present invention but are not necessarily used to limit or otherwise define the scope of the present invention.

Compositions

| Ingredients: | | | | | | | |
|---|---|---|---|---|---|---|---|
| (% by weight) | I | II | III | IV | V | VI | VII |
| Phosphoric acid | 12 | 12 | 10 | 15 | 7.3 | 6.3 | — |
| Oxalic acid | — | — | — | — | — | — | 5 |
| Sulfuric acid | — | — | — | — | — | — | — |
| Formic acid | 1.8 | 0.8 | 1.9 | 0.2 | 1.3 | 1.3 | 1.9 |
| HEDP | 0.19 | — | — | — | 0.19 | — | — |
| Dobanol 91-8 | 2.2 | 2.2 | 2.2 | 2.2 | — | — | 2.2 |
| Luviskol K60 ® | — | 0.05 | — | — | — | — | — |
| Kelzan T ® | — | 0.28 | 0.28 | — | — | — | 0.28 |
| Perfume⁽*⁾ | 0.25 | 0.25 | 0.25 | 0.25 | 0.25 | 0.25 | — |
| Waters & Minors | Up to 100 | | | | | | |
| Ingredients | | | | | | | |
| (% by weight) | VIII | IX | X | XI | XII | XIII | XIV |
| Phosphoric acid | 12 | — | — | — | 10 | 15 | 8 |
| Oxalic acid | — | — | — | — | 2 | — | 3 |
| Sulfuric acid | — | 10 | 8 | 15 | — | — | — |
| Formic acid | 1.8 | 0.8 | 1.9 | 0.2 | 1.9 | 1.9 | 1 |
| HEDP | — | — | — | 0.15 | — | — | 0.15 |
| Dobanol 91-8 ® | — | 2.2 | 2.2 | — | — | — | — |
| Luviskol K60 ® | — | — | — | — | — | — | — |
| Kelzan T ® | — | — | 0.28 | — | — | — | — |
| Perfume⁽*⁾ | — | 0.25 | 0.25 | — | 0.25 | 0.25 | — |

| | |
|---|---|
| Waters & Minors | Up to 100 |

The pH of the examples herein is below 7.
Phosphoric acid is purchased from J. T. Baker.
Formic acid is supplied by Fluka.
Oxalic acid is supplied by MERCK.
Sulfuric is supplied by BASF.
HEDP (etidronic acid) is a chelating agent supplied by Monsanto.
Dobanol 91-8 ® is an ethoxylated (EO 8) C₉₋₁₁ alcohol nonionic surfactant supplied by Shell.
Kelzan T ® is a Xanthan gum supplied by Kelco.
Luviskol K60 ® is a Polyvinylpyrrolidone supplied by BASF.
Perfume⁽*⁾ comprising a mixture of Floral Acetate and Eucalyptol.

The above exemplified compositions (I-XIV) show excellent limescale removal performance when used as washing appliance cleaners in the method according to the present invention.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of cleaning the interior surfaces of a non-loaded washing machine or a non-loaded automatic dishwasher with a liquid composition, by forming in said washing machine or automatic dishwasher an aqueous liquor comprising water and said liquid composition, wherein said liquid composition comprises an acid system comprising formic acid and an acid forming a slightly water soluble calcium salt.

2. A method according to claim 1, wherein said liquid composition is a liquid aqueous composition.

3. A method according to claim 1, wherein said liquid composition is diluted up to about 2000 times its own weight with water.

4. A method according to claim 1, wherein said aqueous liquor is used at a temperature of from the temperature of unheated water to about 95° C.

5. A method according to claim 1, wherein said acid forming a slightly water soluble calcium salt is an organic acid or an inorganic acid or a mixture thereof.

6. A method according to claim 1, wherein said acid forming a slightly water soluble calcium salt is selected from the group consisting of: phosphoric acid; sulfuric acid and oxalic acid and mixtures thereof.

7. A method according to claim 1, wherein said acid forming a slightly water soluble calcium salt is phosphoric acid.

8. A method of cleaning the interior surfaces of a non-loaded washing machine or a non-loaded automatic dishwasher with a liquid composition, by forming in said washing machine or automatic dishwasher an aqueous liquor comprising water and said liquid composition, wherein said liquid composition comprises an acid system comprising formic acid and an acid forming a slightly water soluble calcium salt, wherein said acid forming a slightly water soluble calcium salt is phosphoric acid.

9. A method according to claim 1, wherein the aqueous liquor formed is an acidic aqueous liquor.

10. A method according to claim 1, wherein said acid system is present in a sufficient amount to form an acidic aqueous liquor having a pH of below about 4.

11. A method according to claim 1, wherein said liquid composition comprises of from about 1.01% to about 28% by weight of the total composition of said acid system.

12. A method according to claim 1, wherein said liquid composition comprises of from about 0.01% to about 3% by weight of the total composition of formic acid.

13. A method according to claim 1, wherein said liquid composition comprises of from about 1% to about 25% by weight of the total composition of said acid forming a slightly water soluble calcium salt, or mixtures thereof.

14. A method according to claim 1, wherein said liquid composition additionally comprises a chelating agent.

15. A method according to claim 14, wherein said chelating agent is selected from the group consisting of: amino aminotri (methylene phosphonic acid); di-ethylene-triamino-pentaacetic acid; diethylene triamine penta methylene phosphonate; 1-hydroxy ethane diphosphonate; 1-hydroxy ethane diphosphonic acid; ethylenediamine N,N′-disuccinic acid; and mixtures thereof.

16. A method according to claim 1, wherein said liquid composition additionally comprises a chelating agent selected from the group consisting of: alkali metal ethane 1-hydroxy diphosphonate; and ethane 1-hydroxy diphosphonic acid; and mixtures thereof.
